(19) United States
(12) Patent Application Publication
(10) Pub. No.: US 2005/0244705 A1
(43) Pub. Date: Nov. 3, 2005

(54) Electrolyte injection and degas method of electric energy storage device

(76) Inventors: Jing-Yih Cherng, Taipei City (TW); Ming-Lung Chen, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/833,139

(22) Filed: Apr. 28, 2004

(51) Int. Cl. H01M 2/36

(52) U.S. Cl. 429/52; 429/118

(57) ABSTRACT

An electrolyte injection and degas method of electric energy storage device comprises the following steps. A pipeline connected with the exterior is installed in an electric energy storage device. Next, gas in the battery core of the electric energy storage device is extracted via the pipeline to form a vacuum negative pressure state. Electrolyte is then injected into the battery core via the pipeline. Next, the battery core is kept at the vacuum negative pressure state and charged for activation. Subsequently, gas generated when the battery core is charged for activation is extracted via the pipeline. A clamp layer for covering the pipeline of the electric energy storage device is then heat sealed. Finally, the pipeline is extruded by hot melt during heat sealing. A degas bag can be saved, and the size of the electric energy storage device can be decreased to lower the cost.

### FIELD OF THE INVENTION

The present invention relates to an electrolyte injection and degas method of electric energy storage device and, more particularly, to a method used in a rechargeable electric energy storage device for uniform injection of electrolyte and discharge of gas generated when the battery core of the electric energy storage device is injected with electrolyte and charged for activation.

### BACKGROUND OF THE INVENTION

Along with continual progress of the science and technology, various electronic products such as mobile phones, personal digital assistants (PDA) and handheld computers have become inevitable tools in our lives. The requirement for quantity and quality of electric energy storage devices gets higher and higher because of the trend toward compactness of today's electronic products. It is necessary to design electric energy storage devices according to the characteristics of matched electronic products. Therefore, electric energy storage devices need to be miniaturized and manufactured using a green process for reducing pollution to the environment. Moreover, their lifetimes need to be lengthened.

For an existent electric energy storage device like a lithium polymer secondary battery, the injected electrolyte will distribute unevenly, hence reducing the usage performance of the electric energy storage device. Moreover, there will be residual electrolyte in a clamp layer of the electric energy storage device after injection of the electrolyte. Therefore, the electrolyte will contaminate the sealed edge during edge seal, hence causing incomplete edge seal and thus gas leakage. This will affect the yield of the electric energy storage device. For instance, in the disclosure of U.S. Pat. No. 6,371,996, the opening side of an envelope film body (battery clamp layer) for accommodating a battery element (battery core) is made larger than a prescribed shape and dimension and used as a temporary reservoir region for injection of electrolyte. When performing the injection of electrolyte, a prescribed electrolyte is injected into this temporary reservoir region. After the electrolyte permeates the battery element side, sealing is performed between the temporary reservoir region and the accommodation portion for accommodating the battery element. Finally, the temporary reservoir region of the envelope film body is cut. In the above disclosure, because there was residual electrolyte in the temporary reservoir region (i.e., in the envelope film body), the problem of edge contamination by the electrolyte will occur when performing edge seal, hence causing incomplete edge seal and thus gas leakage. This will affect the yield.

Besides, when an electric energy storage device is charged for activation for the first time, the electrolyte may easily generate gas in the battery core of the electric energy storage device, hence reducing the usage performance of the electric energy storage device. As shown in FIG. 1, a conventional electric energy storage device 10 comprises a battery core 12 adjacent to a degas bag 16, a degas passageway 14 is reserved between the degas bag 16 and the battery core 12 to when performing hot sealing let the degas bag 16 and the battery core be connected. When the electric energy storage device 10 is charged for activation for the first time, part gas generated by the electrolyte of the battery core 12 will be discharged to and collected in the degas bag 16. During discharge of gas, the electrolyte of the battery core 12 will also flow into the degas bag 16 or remain in the battery core 12 and the clamp layer of the degas bag 16, hence causing contamination of electrolyte and lowering the lifetime of the electric energy storage device 10. Moreover, the degas bag 16 occupies a certain space and has a certain cost, hence increasing the size and cost of the electric energy storage device 10.

### SUMMARY OF THE INVENTION

The primary object of the present invention is to provide an electrolyte injection and degas method of electric energy storage device for uniformly distributing an electrolyte after the electrolyte is injected into an electric energy storage device and also reducing contamination of electrolyte and gas leakage when performing edge seal, thereby increasing the usage lifetime of the electric energy storage device.

Another object of the present invention is to provide an electrolyte injection and degas method of electric energy storage device to reduce the size and cost of an electric energy storage device.

To achieve the above objects, the present invention providesan electrolyte injection and degas method of electric energy storage device comprising the following steps. A pipeline connected with the exterior is installed in a battery core at a non-conducting tab end of an electric energy storage device. Next, gas in the battery core of the electric energy storage device is extracted to form a vacuum negative pressure state via the pipeline. An electrolyte is then injected into the battery core of the electric energy storage device via the pipeline. Next, the battery core of the electric energy storage device is kept at the vacuum negative pressure state and charged for activation. Subsequently, part of the gas generated when the battery core is charged for activation is extracted via the pipeline. A clamp layer for covering the pipeline of the electric energy storage device is then heat sealed. Finally, the pipeline is extruded by hot melt during heat sealing.

The various objects and advantages of the present invention will be more readily understood from the following detailed description when read in conjunction with the appended drawings, in which:

### BRIEF DESCRIPTION OF THE DRAWINGS

FIG. 1 is an internal structure diagram of a conventional electric energy storage device;

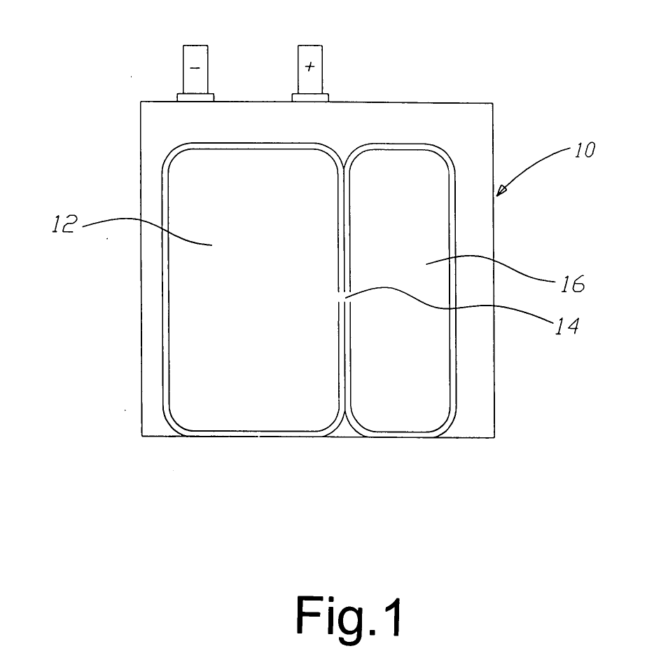

FIG. 2 is a vacuuming structure according to a preferred embodiment of the present invention;

FIG. 3 is a solution injection structure according to a preferred embodiment of the present invention; and

FIG. 4 is a degas structure according to a preferred embodiment of the present invention.

### DETAILED DESCRIPTION OF THE PREFERRED EMBODIMENTS

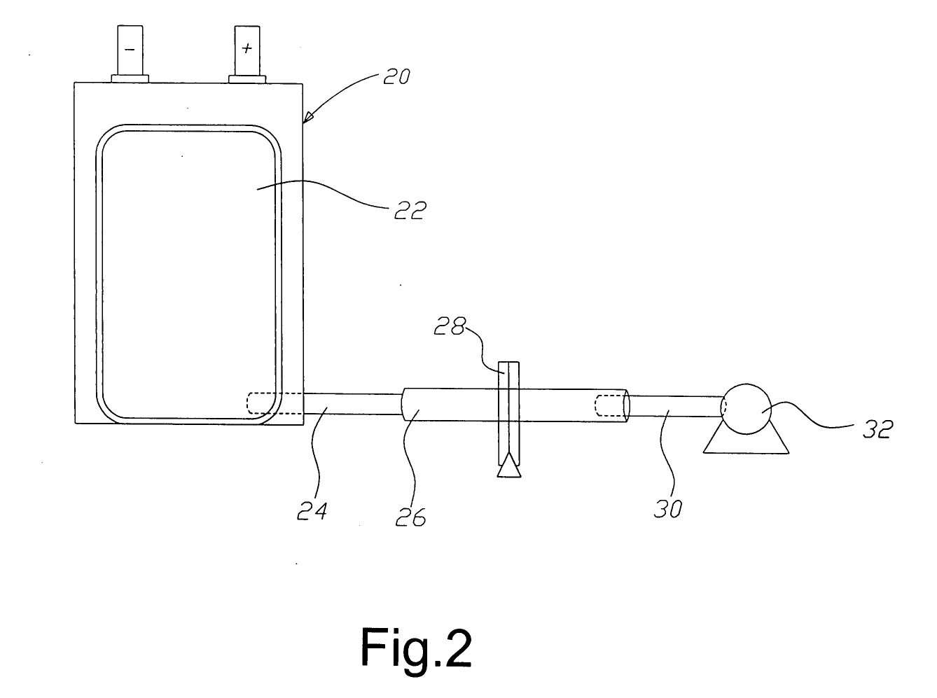

As shown in FIG. 2, an electric energy storage device 20 has a battery core 22 inside. One end of an electrolyte injection and degas pipe 24 is installed in the battery core 22 at a non-conducting tab side of the electric energy storage device 20. The other end of the electrolyte injection and degas pipe 24 is sleeved with a soft pipe 26. The other end of the soft pipe 26 is sleeved with anextraction pipe 30. The other end of the extraction pipe 30 is sleeved with a vacuum pump 32. The soft pipe 26 can be used as an isolation device through a spring clamp 28.

The vacuuming process of the electric energy storage device 20 before injection of electrolyte is as follows. The spring clamp 28 on the soft pipe 26 is first removed. The battery core 22 at the non-conducting tab end of the electric energy storage device 20 makes use of the electrolyte injection and degas pipe 24, the soft pipe 26 and the extraction pipe 30 to form a pipeline. The vacuum pump 32 is used to vacuum the battery core 22. The spring clamp 28 then clamps the soft pipe 26 again after vacuuming to isolate the battery core 22 from the exterior and keep the battery core 22 at a vacuum negative pressure state. The extraction pipe 30 and the vacuum pump 32 are then removed.

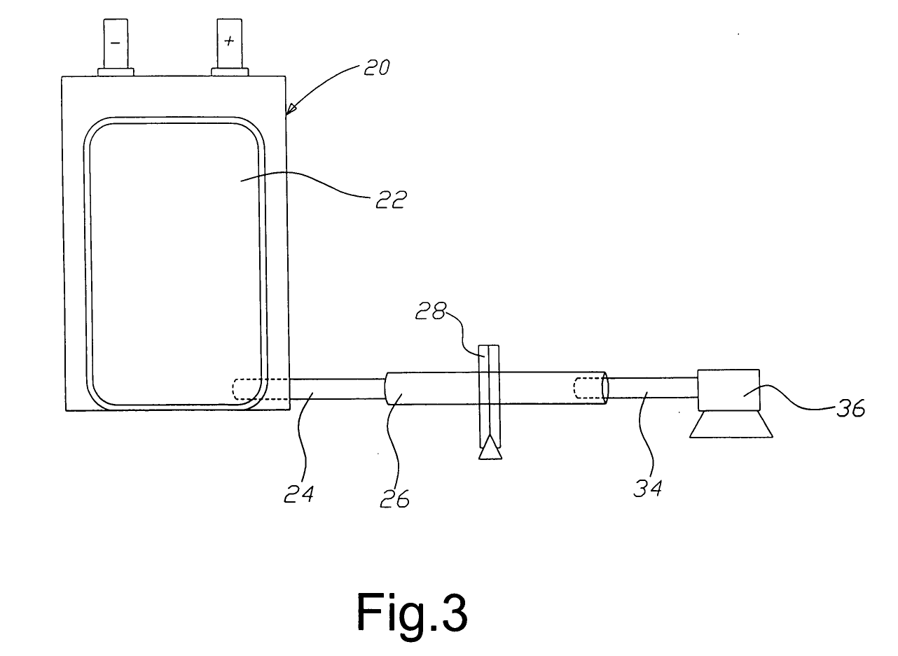

Please also refer to FIG. 3. The electrolyte injection process of the electric energy storage device 20 after vacuuming is as follows. An electrolyte injection pipe 34 is sleeved with the soft pipe 26. The electrolyte injection pipe 34 is sleeved with an electrolyte injection machine 36. The spring clamp 28 is detached. The electrolyte injection machine 36 then injects an electrolyte mixed with an appropriate additive and having no visible bubbles into the battery core 22 via the electrolyte injection pipe 34, the soft pipe 26 and the electrolyte injection and degas pipe 24. The electrolyte injection pipe 34 and the electrolyte injection machine 36 are then removed after injection of the electrolyte. Subsequently, the soft pipe 26 is heat sealed to isolate the battery core 22 from the exterior and also keep the battery core 22 at a vacuum negative pressure state. The battery core 22 can then be charged for activation.

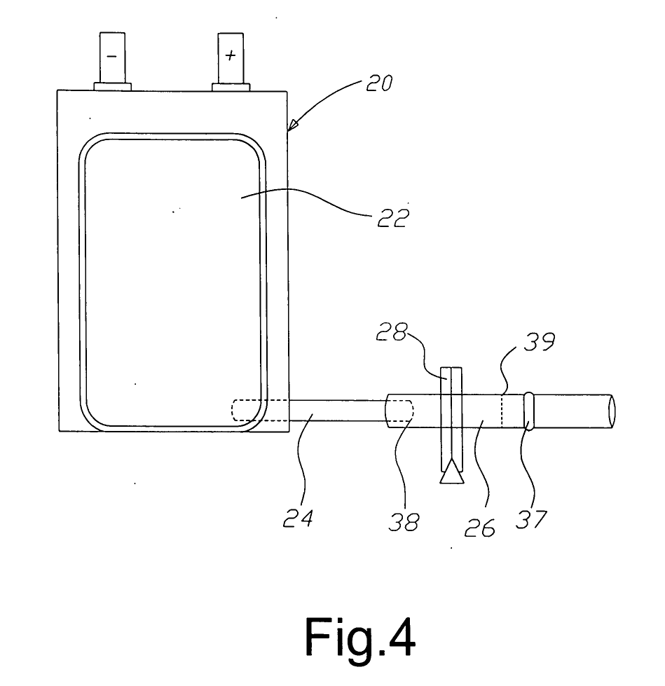

Please refer to FIG. 4. The degas process of the electric energy storage device 20 after the battery core 22 is charged for activation is as follows. After the battery core 22 of the electric energy storage device 20 is charged for activation, the spring clamp 28 clamps between a sleeved position 38 of the soft pipe 26 and the electrolyte injection and degas pipe 24 and a heat-sealed position 37 of the soft pipe 26. The heat-sealed position 37 is then cut at a cut position 39 between the spring clamp 28 and the heat-sealed position 37 to still isolate the battery core 22 from the exterior (please refer to FIG. 2). The extraction pipe 30 connecting the vacuum pump 32 is connected back with the soft pipe 26. The clamp pipe 28 is then removed. Part of gas generated is extracted after the battery core 22 is charged for activation. Next, the clamp layer of the electric energy storage device 20 for covering the electrolyte injection and degas pipe 24 is heat sealed. The electrolyte injection and degas pipe 24 and the electrolyte in the pipeline are then extruded out of the clamp layer by heat melt.

In summary, the electrolyte injection and degas process of electric energy storage device of the present invention is as follows. The electrolyte injection and degas pipe 24 is installed at the non-conducting tab end of the electric energy storage device 20 to connect the battery core 22 with the exterior. The electrolyte injection and degas pipe 24, the soft pipe 26 and the extraction pipe 30 form an extraction pipeline. The vacuum pump 32 is used to extract the battery core 22 to form a vacuum state. The spring clamp 28 clamps the soft pipe 26 to isolate the battery core 22 from the exterior. The extraction pipe 30 and the vacuum pump 32 are then removed. The electrolyte injection pipe 34 connecting the electrolyte injection machine 36 is then sleeved with the soft pipe 26, and the spring clamp 28 is detached. The electrolyte mixed with the appropriate additive is then injected into the battery core 22. The soft pipe 26 is then heat sealed to isolate the battery core 22 from the exterior and also keep the battery core 22 at a vacuum negative pressure state.

Subsequently, the spring clamp 28 clamps between the sleeved position 38 of the soft pipe 26 and the electrolyte injection and degas pipe 24 and the heat-sealed position 37 of the soft pipe 26. The heat-sealed position 37 of the soft pipe 26 is then cut to still isolate the battery core 22 from the exterior. The extraction pipe 30 connecting the vacuum pump 32 is sleeved with the soft pipe 26. The clamp pipe 28 is then detached. Part of gas generated after the battery core 22 is charged for activation is extracted. Next, the clamp layer of the electric energy storage device 20 for covering the electrolyte injection and degas pipe 24 is heat sealed. The electrolyte injection and degas pipe 24 and the electrolyte in the pipeline are then extruded out of the clamp layer by heat melt.

Because the material of the electrolyte injection and degas pipe 24 is a plastic material capable of tightly bonding with the clamp layer, complete edge seal will be accomplished and leakage of gas won't occur during heat sealing. Moreover, the electrolyte remaining on the pipe wall of the electrolyte injection and degas pipe 24 will be removed when the electrolyte injection and degas pipe 24 is extruded during heat sealing. Therefore, contamination of electrolyte leakage of gas at the sealed edge won't happen. Besides, the appropriate additive mixed in the electrolyte can limit the generated gas under a certain amount when the battery core 22 is charged for activation. Through control of the injected amount and the prescription of the electrolyte, the degas process after the battery core 22 is charged for activation may be omitted. Therefore, the degas bag 16 can be saved to lower the cost of the electric energy storage device 20. This electrolyte injection and degas method can apply to electric energy storage devices like various kinds of batteries and electric double layer capacitors.

Besides, after the battery core 22 of the electric energy storage device 20 is vacuumed to form a negative pressure state, the spring clamp 28 clamps the soft pipe 26 or a stopper blocks up the soft pipe 26 or the soft pipe 26 is heat sealed to keep the battery core 22 at a vacuum negative pressure state. A semi-finished product of the electric energy storage device 20 is thus formed. These semi-finished products can be placed and stored in storehouses or delivered to sale places. The manufacture can perform subsequent steps (injection of the electrolyte) to the semi-finished products according to orders to obtain the electric energy storage devices. In this way, the usage lifetime of the electric energy storage device 20 can be lengthened.

After the electrolyte is injected into the electric energy storage device 20, it is necessary to charge and activate the battery core 20. After the battery core 20 is charged for activation, the life of the electric energy storage device starts. Because the electric energy storage device 20 has a certain lifetime, if it is stored in the storehouse for a period of time after the battery core is charged for activation, its lifetime will decrease. Through the electrolyte injection and degas method of the present invention, the electric energy storage device 20 can be first processed to form a semi-finished product stored in the storehouse. The subsequent step of injecting the electrolyte can be performed according to orders. In this way, the quality of the electric energy storage device 20 can be maintained. The manufacturer can always provide new goods to the sellers without the need of storing too many finished products, hence accomplishing real-time management of production. Moreover, the usage lifetime of the electric energy storage device 20 can be increased.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be included within the scope of the invention as defined in the appended claims.

1. An electrolyte injection method of electric energy storage device comprising the steps of:
installing a pipeline in an electric energy storage device to connect the battery core of the electric energy storage device with the exterior;
injecting an electrolyte into said battery core of said electric energy storage device via said pipeline; and
hot-sealing a clamp layer covering said pipeline of said electric energy storage device and then extruding said pipeline out by hot melt during hot sealing.

2. The method as claimed in claim 1, wherein said battery core is charged for activation after hot-sealing said clamp layer for covering said pipeline of said electric energy storage device.

3. The method as claimed in claim 1, wherein said pipeline is installed in said battery core at a non-conducting tab end of said electric energy storage device in the step of installing said pipeline.

4. The method as claimed in claim 1 further comprising the step of extracting gas in said battery core of said electric energy storage device via said pipeline to form a vacuum negative pressure state before the step of injecting an electrolyte into said battery core of said electric energy storage device via said pipeline.

5. The method as claimed in claim 1 further comprising the step of adding an appropriate additive into said electrolyte in the step of injecting said electrolyte.

6. An electrolyte injection and degas method of electric energy storage device comprising the steps of:
installing a pipeline in an electric energy storage device to connect the battery core of the electric energy storage device with the exterior;
injecting an electrolyte into said battery core of said electric energy storage device via said pipeline;
charging said electric energy storage device for activation;
extracting gas generated after said battery core of said electric energy storage device is charged for activation via said pipeline; and
hot-sealing a clamp layer for covering said pipeline of said electric energy storage device and then extruding said pipeline out by hot melt during hot sealing.

7. The method as claimed in claim 6, wherein said pipeline is installed in said battery core at a non-conducting tab end of said electric energy storage device in the step of installing said pipeline.

8. The method as claimed in claim 6 further comprising the step of extracting gas in said battery core of said electric energy storage device to form a vacuum negative pressure state before the step of injecting an electrolyte into said battery core of said electric energy storage device via said pipeline.

9. The method as claimed in claim 6 further comprising the step of adding an appropriate additive into said electrolyte in the step of injecting said electrolyte.
